(19) United States
(12) Patent Application Publication
(10) Pub. No.: US 2022/0342903 A1
(43) Pub. Date: Oct. 27, 2022

(54) A DATA EXTRACTION METHOD

(71) Applicant: UMWELT (AUSTRALIA) PTY LIMITED, Teralba, New South Wales (AU)

(72) Inventors: Anthony VAN DER HORST, New South Wales (AU); Stephen LYONS, New South Wales (AU); Ruslan BATIROV, New South Wales (AU); Tim PROCTER, New South Wales (AU)

(21) Appl. No.: 17/620,231

(22) PCT Filed: Jun. 17, 2020
(86) PCT No.: PCT/AU2020/050610

§ 371 Date: Dec. 17, 2021

(30) Foreign Application Priority Data
Jun. 17, 2019 (AU) 2019902094

(51) Int. Cl. G06F 16/25; G06F 16/174; G06F 16/2455

(52) U.S. Cl. CPC G06F 16/258; G06F 16/1748; G06F 16/2455

(57) ABSTRACT

Described herein is a method (100) of extracting data from a dataset of files stored in a database (109). The method (100) including step (101) of executing a conversion procedure to convert the dataset of files into a plurality (N) of structured binary files. At step (102) the structured binary files are stored in memory. At step (103) a query is received from a user input to extract queried data from the dataset. The query includes a plurality of query arguments. At step (104), the query arguments are input to a data query procedure. The query procedure includes the substeps of: (104a) accessing the structured to binary files in memory; (104b) loading a reference data structure into memory, the reference data structure specifying a list of data classes; (104c) executing a data query algorithm to retrieve a subset of the data determined by the query arguments; and (104d) returning the subset of the data as one or more files having a predetermined file type.

### FIELD OF THE INVENTION

The present invention relates to data extraction and in particular to a system and method for extraction of data from large datasets. The preferred embodiments of the invention will be described with reference to applications such as modelling noise levels in large scale industrial operations. However, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

In big data applications, it is advantageous to be able to efficiently extract large subsets of data from even larger datasets stored in a database. In some applications, rigorous time constraints apply such that the speed of data extraction becomes significant.

The inventors have identified a solution to quickly extract large amounts of data from big datasets, which has particular applications in data modelling such as noise modelling.

In Australia and internationally, laws are implemented to limit the amount of noise generated by industrial applications such as construction and mining. These laws are regulated and enforced through government agencies such as the Environmental Protection Authority and fines apply for non-compliance. For example, the environmental assessment or environmental impact statement for a proposed large scale development requires the preparation of a Noise Impact Assessment that:
provides predictions of the noise levels at sensitive receiver locations;
incorporates an evaluation of feasible and reasonable noise mitigation measures that could be implemented over the life of the development to maintain compliance with noise criteria; and
provides information for the cost-benefit analysis of the project by identifying: the cost implications of machine sound power requirements; specific mine planning requirements to control noise propagation, resource sterilisation to offset the size of the buffer zones or the construction of noise bunds; land acquisition requirements to establish buffer zones; and noise mitigation measures at sensitive receiver locations.

To ensure compliance with these laws, companies employ sophisticated noise monitoring and noise modelling technologies. Such noise models should ideally predict the noise levels that will be generated by a proposed complex or staged development and simulate the progression of the planned operations using a number of representative development stages.

Noise modelling during the planning and development phase of large industrial operations, for example in the mining industry, is a time-consuming and resource-intensive task, both in terms of manual labour and computer computations. The outputs of the modelling process can also be used to optimise noise outcomes during the operational phase of mining, with noise modelling being undertaken in conjunction with monitoring, to assess compliance with statutory noise limits and strategies to reduce noise impacts.

The inventors have identified that specific advantages can be achieved if the speed of the data management process in noise modelling can be improved. In particular, if the speed of the data management can be sufficiently improved, it may facilitate the evaluation of noise performance in real-time or near real-time, and therefore provide opportunity to respond to changes in environmental conditions and operational tempo in order to better meet license conditions and operational requirements.

In the context of the above, the present inventors have identified a method of more efficiently extracting data from large datasets such as noise modelling data. The embodiments of the invention described herein can form a core module of a real-time noise management system and form the underlying data management engine of the inventors' noise modelling system. However, the methods described herein have applications other than noise modelling such as broader environmental monitoring and management including air, dust and water quality monitoring/management.

### SUMMARY OF THE INVENTION

In accordance with a first aspect of the present invention there is provided a method of extracting data from a dataset of files stored in a database, the method including the steps:
executing a conversion procedure to convert the dataset of files into a plurality (N) of structured binary files,
storing the structured binary files in memory;
receiving a query from a user input to extract queried data from the dataset, the query including a plurality of query arguments;
inputting the query arguments to a data query procedure, the query procedure including:
   accessing the structured binary files in memory;
   loading a reference data structure into memory, the reference data structure specifying a list of data classes;
   executing a data query algorithm to retrieve a subset of the data determined by the query arguments; and
   returning the subset of the data as one or more files having a predetermined file type.

In some embodiments, the conversion routine includes:
sequentially reading each file of the dataset of files into memory;
converting each line of each file into a binary structure; and
dividing the data into a plurality (N) of substantially equal segments and populating each one of the N structured binary files with a corresponding data segment.

In some embodiments, the predetermined file type of the returned subset of the data is the same format as the files in the dataset.

In some embodiments, the number (N) of structured binary files generated is equal to the number of computer threads available for the data querying.

In some embodiments, the files in the dataset are comma separated value (.CSV) files.

In some embodiments, the data query algorithm includes running an SQL type query. In one embodiment, the SQL query is a language integrated query (LINQ).

In some embodiments, the step of converting each line of each file into a binary structure includes converting floating point numbers to integers.

In some embodiments, the step of converting each line of each file into a binary structure includes executing a text to binary conversion process.

In some embodiments, the reference data structure includes a resizable array.

In some embodiments, the dataset of files includes a plurality of structured output files from a data model.

In some embodiments, the data model is a noise model. In some embodiments, the data classes include noise sources, noise receivers and meteorological data.

In some embodiments, the steps of executing a conversion procedure and storing the structured binary files in memory are performed elastically and in parallel across a number of available computer threads. In some embodiments, the number of available computer threads is calculated by dynamically querying a computer processor.

In accordance with a second aspect of the present invention, there is provided a user interface configured to facilitate a method according to the first aspect.

In accordance with a third aspect of the present invention, there is provided a non-transient computer readable medium having instructions stored thereon that, when executed on a computer processor, the computer processor carries out the method according to the first aspect.

In accordance with a fourth aspect of the present invention, there is provided a computer system configured to carry out a method according to the first aspect.

### BRIEF DESCRIPTION OF THE DRAWINGS

Preferred embodiments of the disclosure will now be described, by way of example only, with reference to the accompanying drawings in which:

FIG. 1 is a process flow diagram illustrating the primary steps in a method of extracting data from a dataset of files stored in a database;

FIG. 2 is a schematic system level diagram of a computer system capable of implementing the method illustrated in FIG. 1;

FIG. 3 is a schematic diagram illustrating data flow in the method of FIG. 1; and

FIG. 4 is a process flow diagram illustrating sub-steps in a data query procedure.

### DETAILED DESCRIPTION

### System Overview

The present invention relates to a method for data extraction. Embodiments of the invention described herein are related to extraction of data from a large dataset of noise modelling data. However, it will be appreciated that the method is applicable to other types of datasets and big data applications.

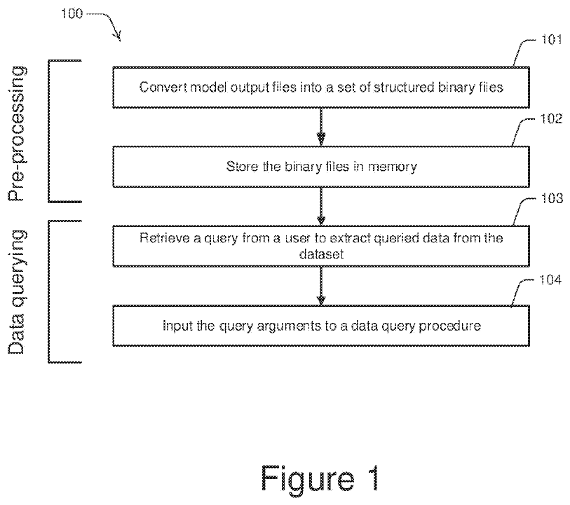

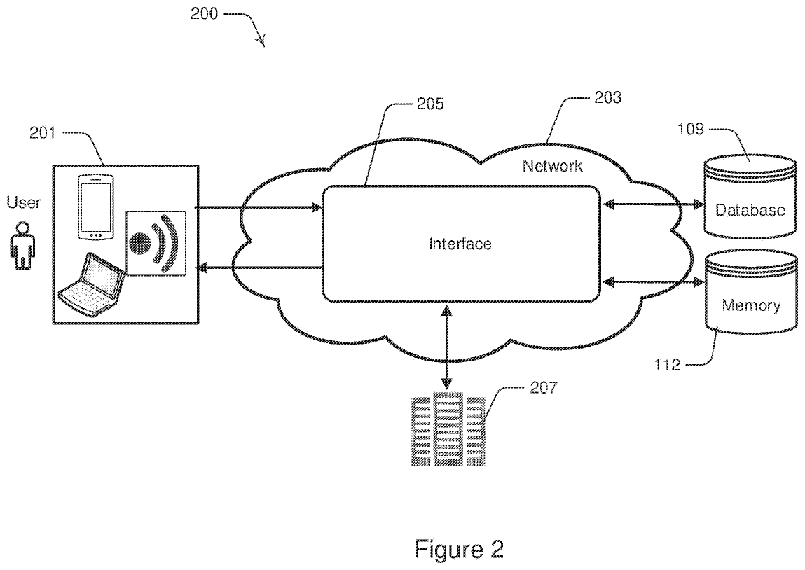

Referring initially to FIG. 1, there is illustrated a flow chart outlining the primary steps in a method 100 of extracting data from a dataset of files stored in a database. Method 100 is configured to operate in a computer system such as system 200 illustrated in FIG. 2. The operation of method 100 will be described herein with reference to this system. System 200 includes a user computer 201, which includes a network communication device to allow a user to access a network 203 such as the Internet. Computer 201 may be any type of computer device such as a desktop computer, laptop computer, tablet computer or smart phone. Network 203 hosts an interface 205 such as a web interface or software “App” accessible by computer 201 to control a graphical display and/or receive user input. Interface is hosted by a server 207 which may be co-located with computer 201 or remotely located.

The initial dataset may include a large single file or a number (typically a very large number) of individual files. In the case of multiple files, each of the individual files includes a plurality of variables in a known structured form. The structure of the file or files must be known or learned prior to method 100 being performed. However, method 100 is able to be performed on substantially any structured data. By way of example, the dataset may comprise a large number of Comma Separated Values (.csv) files storing a number of variables in a standard tabular format. Following the noise modelling example, the variables of each file may include time, date, site description, site location, noise source type, description and location and meteorological data. The size of the files in the dataset will typically be in the order of megabytes or gigabytes.

By way of example only, suitable .csv type files representing output data of a noise model are included below. These represent example files of the initial dataset for the specific application of noise modelling.
File ‘Meteorological Conditions’, comma-delimited text file (*_Met.csv)
Column 1 (Text): Meteorological Key
Column 2 (Number): Air Temperature
Column 3 (Number): Humidity
Column 4 (Number): Wind Speed
Column 5 (Number): Wind Direction
Column 6 (Number): Vertical Temperature Gradient
Column 7 (Number): Meteorological Probability
- - -
File ‘Receivers’, comma-delimited text file (*_Receivers.csv)
Column 1 (Number): Receiver ID
Column 2 (Number): Property ID
Column 3 (Number): Property Name
Column 4 (Text): Owner Name
Column 5 (Number): X in ENM coordinate system
Column 6 (Number): Y in ENM coordinate system
Column 7 (Number): X in MGA coordinate system
Column 8 (Number): Y in MGA coordinate system
Column 9 (Number): Receiver Ground Elevation
Column 10 (Number): Receiver Height
Column 11 (Number): Receiver Top Elevation
Column 12 (Number): PSNL
- - -
File ‘Sources’, comma-delimited text file (*_Sources.csv)
Column 1 (Number): Source ID
Column 2 (Text): Machine Name
Column 3 (Number): Activity
Column 4 (Number): X in MGA coordinate system
Column 5 (Number): Y in MGA coordinate system
Column 6 (Number): Source Ground Elevation
Column 7 (Number): Source Height
Column 8 (Number): Source Top Elevation
Column 9 (Number): Machine Reference ID
Column 10 (Text): Machine Reference Description
Column 11 (Number): dBLin
Column 12 (Number): dBA
Column 13 (Number): CorrectiondB
Column 14 (Number): Utilisation
Column 15 (Number): corrdBLin
Column 16 (Number): corrdBA
Columns 17-46 (Number): L Frequency
- - -
ENM modelling output files, comma-delimited text files (*.csv)
Column 1 (Text): Meteorological Key
Column 2 (Number): X in ENM coordinate system
Column 3 (Number): Y in ENM coordinate system
Column 4 (Number): Receiver ID
Column 5 (Number): Source ID, if −9999 then all sources
Column 6 (Number, one decimal point precision): Total Sound Pressure Level
Columns 7-36 (Numbers, one decimal point precision): Sound Pressure Level (SPL) for each frequency
- - -

At step 101, a conversion procedure is executed to convert the dataset of files into a plurality (N) of structured binary files. In some embodiments, this step may be performed by:
sequentially reading each file of the dataset of files into memory 112;
converting each line of each file into a binary structure;
dividing the data into a plurality (N) of substantially equal segments; and
populating each one of the N structured binary files with a corresponding data segment.

Each of the structured binary files (of .bin format) has a data structure of predefined form. Knowledge of this data structure allows for efficient extraction of data during querying.

The step of converting each line of each file into a binary structure may include, inter alia, converting floating point numbers to integers and/or executing a text to binary conversion process.

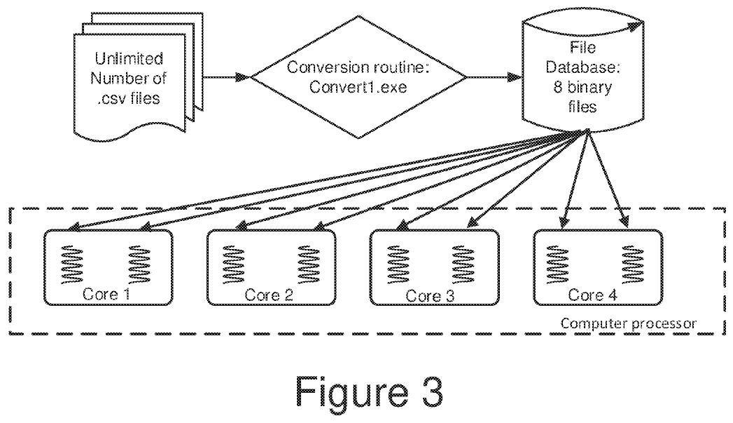

The number (N) of structured binary files generated is preferably equal to the number of computer threads available for the data querying. Here, ‘threads’ represent threads of execution indicating a way for a computer program to divide itself into two or more simultaneously (or pseudo-simultaneously) running tasks. A thread may represent the smallest sequence of programmed instructions that can be managed independently by a process scheduler, Matching the number of files to the number of available computer threads optimises the processing power available across the threads to more efficiently process the data. By way of example, the number of binary files generated may be 8 so as to be optimised for a single 4-core computer (a 4-core computer supports 8 computer threads) to process the 8 files in parallel. This is illustrated schematically in FIG. 3. Under such a configuration, each computer thread is able to independently process a corresponding binary file in a parallel arrangement. It will be appreciated that the number of binary files may be greater or less than 8 so as to match the number of computer threads available.

An example 12 byte binary file format (reference data structure) for a noise model output scenario is included in the table below.

| | Byte | | |
|---|---|---|---|
| Element | Position | Type | Description |
| Rec ID | 0 | Short (16 bit signed | Receiver Identification |
| | | integer) | Number |
| Met Key | 2 | Char (6 bytes) | Meteorological Key |
| | | | Identification Text |
| Sor ID | 8 | Short (16 bit signed | Source Identification |
| | | integer) | Number |
| dBA | 10 | Short (16 bit signed | Modelled sound pressure |
| | | integer) | level (SPL) converted from |
| | | | one decimal point number |
| | | | to integer number |
| | | | (example: 25.3 × 10 = 253) |
| . . . | | | |

At step 102, the structured binary files are stored in memory 112. The binary files may be loaded into memory as sets and vectors of data such as a “list of records”. By way of example, in a .NET framework, this allows the binary files to be stored as a List (of T) Classes. List class represents a list of objects that can be efficiently accessed by index. In the noise modelling example, data classes include noise sources, noise receivers and meteorological data. In the .NET framework, the reference data structure includes a resizable array.

In other embodiments, other programming frameworks may be used which are capable of handling lists, sets and vectors of data. Nonlimiting examples include the C or Python programming languages.

The specific parameters (e.g. lists and vectors) of data included in the initial dataset act as an index of the binary files and are able to be used as filter parameters during the subsequent querying process. The extent of the parameters of the initial dataset also defines the boundaries of the data included in the data to be queried.

Memory 112 may be locally connected to server 207 and/or computer 201 or accessible over a network as illustrated in FIG. 2. When performed locally on computer 201, memory 112 may represent the RAM of computer 201.

Steps 101 and 102 represent pre-processing steps to convert the input data files to a suitable number of binary files, each having a reference data structure for efficient population in a subsequent querying process. In the embodiment illustrated in FIG. 3, a 4-core computer is used for the querying so 8 structured binary files are generated. The querying procedure may be performed locally by computer 201 or remotely by server 207 and/or another computer resource. The querying procedure may also be performed collectively by a number of different computer devices in a distributed resources arrangement. The pre-processing steps need only be performed when the data stored in the dataset of files is updated. Thus, pre-processing steps 101 and 102 may be performed routinely such as hourly, daily, weekly etc.

In some embodiments, pre-processing steps 101 and 102 are performed elastically and in parallel across the number of available computer threads (on a single or distributed resource processor system). The current availability of computer threads is calculated dynamically by querying the processor and a corresponding number of binary data structures are generated. Thus, each time pre-processing steps 101 and 102 are performed, a different number of structured binary files may be generated.

Steps 103 and 104 will now be described, which relate to a querying routine initiated by a user. These querying steps may be performed at any time subsequent to pre-processing steps 101 and 102.

At step 103, a query is input from a user of computer 201 to extract queried data from the dataset. The query includes a number of arguments including selected values of variables such as time periods and geographic locations. The query arguments may be entered through respective fields of a user interface hosted by computer 201 in an online or offline application. In some embodiments, the particular parameters entered by the user through the interface may be different from the actual query arguments that are used by computer 201. In these embodiments, an algorithm converts the query parameters to suitable query arguments.

The query arguments represent specific filter parameters which correspond to a specific subset of the overall data in the structured binary data files. In the noise modelling data example, the query arguments may be the numerical input parameters corresponding to noise receivers, noise sources and meteorological keys.

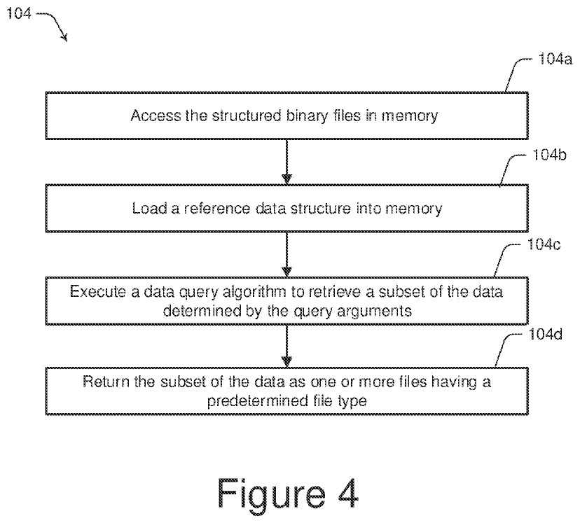

At step 104, the query arguments are input to a data query procedure. The query procedure includes a number of sub-steps as illustrated in FIG. 4. These include, at step 104a, accessing the structured binary files in memory 112, including loading all of the binary files created in 102 into memory for quick access. At step 104b, a reference data structure is loaded into memory. The reference data structure specifies a list of data classes and forms the underlying data structure in which the queried data will populate. At step 104c, a data query algorithm is executed to retrieve a subset of the data determined by the query arguments. By way of example, the query algorithm may be an SQL type query using LINQ (Language Integrated Query), which is a Microsoft programming model and methodology that adds query capability into .NET based programming routine including SQL, memory arrays and parallelism.

In the example of the noise modelling data, the reference data structure may take the form:

| List (Of T) | | | |
|---|---|---|---|
| Class | Element | Type | Description |
| oMatrix | Rec | Short (16 bit signed | Receiver identification |
| | | integer) | number |
| | Met | Char (6 bytes) | Meteorological Key |
| | | | Identification Text |
| | Sor | Short (16 bit signed | Source machine activity |
| | | integer) | description |
| | Lev | Single (32 bit single | Stored sound pressure |
| | | precision floating | level (SPL) converted from |
| | | point number | integer number to single |
| | | | precision floating number |
| | | | (example: 253/10 = 25.3) |

Finally, at step 104d, the subset of the data satisfying the query arguments is returned as one or more files having a predetermined file type. In some embodiments, the predetermined file type of the returned subset of the data is the same format as the files in the dataset (e.g. a .csv file). In one embodiment, the returned subset of data is a binary .bin file. In general, the file format of the returned data is dependent on the particular application and software program used to display and/or further process the data.

A further aspect of the invention relates to a user interface configured to facilitate a method as described above. The user interface may be rendered on computer 201 and hosted by server 207 via network 203.

The present invention may also be embodied as an executable set of software instructions. In this regard, one embodiment of the invention provides a non-transient computer readable medium having instructions stored thereon that, when executed on a computer processer, the computer processor carries out the method as described above.

Example Implementation with Noise Modelling

Although the above described method is applicable to a range of applications, an example application of quickly querying noise modelling data is described below.

A probabilistic noise model was developed to prepare a Noise Impact Statement as part of a broader environmental assessment or environmental impact statement for proposed large scale development sites (such as mining and construction sites). The model was used to simulate and predict the noise levels that will be generated by a proposed complex or staged development at a number of representative development stages.

The noise model takes as inputs:
all possible noise sources that may reasonably be expected when a development is fully operational;
the location of each noise source according to the development stage and the associated operating times;
the sound power levels of the equipment fleet, ancillary equipment, material processing and handling facilities and material dispatch facilities. This includes an assessment of impulse, tonal or low frequency noise sources;
the topographic of the region surrounding the development;
meteorological conditions that enhance or retard the propagation of the sound; and
the location of all sensitive noise receivers.

Typically, the meteorological scenarios include wind speeds divided into seven to eight intervals, wind direction based on eight compass intervals and temperature gradients representing A to D class stability conditions, and E class, F class and G class stability conditions. The proportion of time each of these combinations applies is combined with the resulting predicted noise level in order to determine the percentage of time the target project-specific noise level is likely to be exceeded. Noise contours are used to present the isopleths of the noise levels that are exceeded a predefined percentage of the time. The noise modelling tool was developed to also accommodate different input data streams from real-time monitoring systems, GIS and GPS.

The generated noise model is capable of generating in the order of 40 to 80 million lines of discrete one third octave noise level results. A query tool was required which could compute a total noise or sound pressure level at each noise receiver for specific constraint parameters such as temporal and diurnal parameters, fleet sets, fleet alternatives, sound attenuation alternatives, meteorological conditions, geographic site locations etc. This required the ability to quickly draw down from a large data set of results and deliver a manageable data set without compromising data integrity to allow an end user to manipulate the data and understand the effect of certain variables on the expected outcome.

In the present example, the noise model input data is stored in three separate .csv files corresponding respectively to noise receiver data, noise source data and meteorological data. An example data structure of the output noise modelling data is as follows:

| List (Of T) | | | |
|---|---|---|---|
| Class | Element | Type | Description |
| oSordata | Sor | Short (16 bit signed | Source identification |
| | | integer) | number |
| | Machine | Char (6 bytes) | Source machine |
| | | | description |
| | Activity | Char (6 bytes) | Source machine |
| | | | activity description |
| | mgaX | Double (64 bit double | X coordinate in MGA |
| | | precision floating | projection |
| | | point number | |
| | mgaY | Double (64 bit double | Y coordinate in MGA |
| | | precision floating | projection |
| | | point number | |
| oRecdata | Rec | Short (16 bit signed | Receiver identification |
| | | integer) | number |
| | enmX | Double (64 bit double | X coordinate in ENM |
| | | precision floating | coordinate system |
| | | point number | |
| | enmY | Double (64 bit double | Y coordinate in ENM |
| | | precision floating | coordinate system |
| | | point number | |
| | mgaX | Double (64 bit double | X coordinate in MGA |
| | | precision floating | projection |
| | | point number | |
| | mgaY | Double (64 bit double | Y coordinate in MGA |
| | | precision floating | projection |
| | | point number | |
| oMetdata | MetKey | Char (6 bytes) | Meteorological Key |
| | | | Identification Text |
| | MetProb | Double (64 bit double | Meteorological Key |
| | | precision floating | Probability Value |
| | | point number | |

A corresponding example noise model results output binary file is as follows:

| List (Of T) | | | |
|---|---|---|---|
| Class | Element | Type | Description |
| oMatrix | Rec | Short (16 bit signed | Receiver identification |
| | | integer) | number |
| | Met | Char (6 bytes) | Meteorological Key |
| | | | Identification Text |
| | Sor | Short (16 bit signed | Source machine activity |
| | | integer) | description |
| | Lev | Single (32 bit single | Stored sound pressure |
| | | precision floating | level (SPL) converted from |
| | | point number | integer number to single |
| | | | precision floating number |
| | | | (example: 253/10 = 25.3) |

In the noise modelling example, the query procedure of step 104 computes total sound pressure level (SPL) at each receiver for specific met key from selected noise sources as logarithmic sum of sound levels:

$$SPL = 10 {LOG}_{10} \{ \sum {10}^{\frac{( SPL 1 + SPL 2 + SPL … )}{10}} \}$$

This computes SPL values for all noise receivers using all met keys and selected noise sources.

A first subquery extracts all records from list ‘oMatrix’ that match selected noise sources ID and creating temporary list q1 with filtered records:
q1=(From records In oMatrix.AsParallel( ) Where selectedSources.Contains(records.Sor)
Select records.Rec, records.Met, records.Sor, records.Lev).ToList( )

A final subquery groups records by receiver ID and met key from temporary list q1 and computes SPL value for each receiver for specific met key as log sum of SPLs:
Query3=(From selrec In q1 Group selrec By Key=New With {Key selrec.Rec, Key selrec.Met} Into Group

Select New With{.Rec=Key.Rec,.Met=Key.Met,.levLog=Math.Log 10(Group.Sum(Function(v)10\hat{ }(selrec.Lev/10)))*10}).ToList( )

The returned results are in the form of a .csv file which can be manipulated and displayed using software such as Microsoft Excel™.

Upon testing the above method using the noise modelling data, it was discovered that the method of the invention could draw-down noise modelling results from a data set of up to 40 to 80 million lines of discrete one third octave noise level results. The execution time of a query was reduced from 20 minutes using a MySQL database in Microsoft Excel to around 5 to 10 seconds using binary database. For this testing, the binary database was represented as binary files embedded within the Microsoft Excel application.

The speed at which the method of the present invention can extract the noise modelling data enables it to operate as an operational tool within a real-time noise monitoring system to process sensed data in real-time or near real-time. Suitable applications for this technology include complex developments such as mining operations and other large commercial and industrial construction sites.

### CONCLUSIONS

The present invention allows a large dataset of results to be interrogated in a fast and efficient manner. In the specific application of noise modelling, the invention allows for the analysis of predicted noise levels for thousands of noise sources, receivers and noise propagation conditions.

The invention involves a new sampling technique, which is capable of drawing down from a large data set of results (e.g. 40 to 80 million lines of discrete one third octave results using a binary database) and deliver a manageable data set without compromising data integrity. This improvement in processing substantially reduces execution time in querying large datasets.

The invention has been used to interrogate the results from a probabilistic noise modelling process and inform the decision making process with respect to: design aspect of the development; sound attenuation requirements; and potential property mitigation or acquisitions. The invention allows users to be able to “subsample” the dataset of results from probabilistic noise models and allow the user to modify individual (or set of) variables to understand the effect on expected noise impacts. The invention is also capable of being used in the evaluation of data in real time.

### Interpretation

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

Reference to the term “database” is intended to refer to any single or distributed store of data. This may be one or more of a single physical data store, a system of locally or remotely located data servers or a cloud based database.

In a similar manner, the term “controller” or “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

Reference throughout this specification to “one embodiment”, “some embodiments” or “an embodiment” means that a particular feature, structure or characteristic described in connection with the embodiment is included in at least one embodiment of the present disclosure. Thus, appearances of the phrases “in one embodiment”, “in some embodiments” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

It should be appreciated that in the above description of exemplary embodiments of the disclosure, various features of the disclosure are sometimes grouped together in a single embodiment, Fig., or description thereof for the purpose of streamlining the disclosure and aiding in the understanding of one or more of the various inventive aspects. This method of disclosure, however, is not to be interpreted as reflecting an intention that the claims require more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

In the description provided herein, numerous specific details are set forth. However, it is understood that embodiments of the disclosure may be practiced without these specific details. In other instances, well-known methods, structures and techniques have not been shown in detail in order not to obscure an understanding of this description.

Thus, while there has been described what are believed to be the preferred embodiments of the disclosure, those skilled in the art will recognize that other and further modifications may be made thereto without departing from the spirit of the disclosure, and it is intended to claim all such changes and modifications as fall within the scope of the disclosure. For example, any formulas given above are merely representative of procedures that may be used. Functionality may be added or deleted from the block diagrams and operations may be interchanged among functional blocks. Steps may be added or deleted to methods described within the scope of the present disclosure.

1. A method of extracting environmental modelling or sensor data from a dataset of files stored in a database, the method including the steps:
executing a conversion procedure to convert the dataset of files into a plurality (N) of structured binary files, wherein the conversion routine includes:
sequentially reading each file of the dataset of files into memory;
converting each line of each file into a binary structure; and
dividing the data into a plurality (N) of substantially equal segments and populating each one of the N structured binary files with a corresponding data segment;
storing the structured binary files in memory;
receiving a query from a user input to extract queried data from the dataset, the query including a plurality of query arguments;
inputting the query arguments to a data query procedure, the query procedure including:
accessing the structured binary files in memory;
loading a reference data structure into memory, the reference data structure specifying a list of data classes relating to the environmental modelling or sensor data;
executing a data query algorithm to retrieve a subset of the data determined by the query arguments; and
returning the subset of the data as one or more files having a predetermined file type.

2. The method according to claim 1 wherein the predetermined file type of the returned subset of the data is the same format as the files in the dataset.

3. The method according to claim 1 wherein the number (N) of structured binary files generated is equal to the number of computer threads available for the data querying.

4. The method according to claim 1 wherein the files in the dataset are comma separated value (.CSV) files containing noise or other related environmental sensor data.

5. The method according to claim 1 wherein the data query algorithm includes running an SQL type query to obtain summarised views of the data.

6. The method according to claim 5 wherein the SQL query is a language integrated query (LINQ).

7. The method according to claim 1 wherein the step of converting each line of each file into a binary structure includes converting floating point numbers to integers.

8. The method according to claim 1 wherein the step of converting each line of each file into a binary structure includes executing a text to binary conversion process.

9. The method according to claim 1 wherein the reference data structure includes a resizable array.

10. The method according to claim 1 wherein the dataset of files includes a plurality of structured output files from a data model and environmental sensor data.

11. The method according to claim 10 wherein the data model is a noise model.

12. The method according to claim 10 wherein the environmental modelling or sensor data is from remotely located noise monitors and weather station.

13. The method according to claim 1 wherein the data classes include noise sources, noise receivers, predicted noise levels and meteorological data.

14. The method according to claim 1 wherein the data classes include measured noise levels and meteorological data.

15. The method according to claim 1 wherein the steps of executing a conversion procedure and storing the structured binary files in memory are performed elastically and in parallel across a number of available computer threads.

16. The method according to claim 15 wherein the number of available computer threads is calculated by dynamically querying a computer processor.

17. The method according to claim 1 wherein the step of executing a conversion procedure is performed in real-time or near real-time.

18. A user interface configured to facilitate a method according to claim 1.

19. A non-transient computer readable medium having instructions stored thereon that, when executed on a computer processer, the computer processor carries out the method according to claim 1.

20. A computer system configured to carry out a method according to claim 1.
